(19) United States
(12) Patent Application Publication
(10) Pub. No.: US 2004/0168163 A1
(43) Pub. Date: Aug. 26, 2004

(54) System and method for shortening class loading process in Java program

(75) Inventors: Ji-young Choi, Seoul (KR); Hyo-jung Song, Seoul (KR); Jung-gyu Park, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/773,292

(22) Filed: Feb. 9, 2004

(30) Foreign Application Priority Data
Feb. 7, 2003 (KR) 10-2003-0007728

(51) Int. Cl. G06F 9/44; G06F 9/45

(52) U.S. Cl. 717/166; 717/116; 717/118; 717/148; 717/151

(57) ABSTRACT

A system for shortening the class loading process in a Java program according to the present invention includes a class loader unit for loading Java program class files from an auxiliary memory, performing linking and initialization processes and generating runtime data; a first memory unit for maintaining the runtime data generated by the class loader unit in an accessible state; a second memory unit for storing the runtime data, which have been loaded into the first memory unit in an accessible state, in the form of images; a runtime data search unit for loading the runtime data, which have been stored in the second memory unit in the form of images, into the first memory unit upon the request of the class loader unit; and an execution unit for executing the runtime data that have been loaded into the first memory unit in an accessible state.

### BACKGROUND OF THE INVENTION

This application claims the priority of Korean Patent Application No. 10-2003-0007728 filed on Feb. 7, 2003, in the Korean Intellectual Property Office, the disclosure of which is incorporated herein by reference.

1. Field of Invention

The present invention relates to a system and method for shortening the class loading process in a Java program. More particularly, the present invention relates to a system and method for shortening the class loading process in a Java program, wherein runtime data generated upon performing the class loading process in the Java program are stored in the form of images and the stored runtime data are retrieved and executed upon future execution of the Java program, thereby shortening the class loading time.

2. Description of the Prior Art

Recently, the size of Java programs (e.g., games, messengers, etc.) operating in mobile terminals has become larger as the use of mobile terminals gradually increased.

However, in order to execute a Java program, a class loading process should be first performed in a Java virtual machine (JVM). Further, in order to complete the class loading process, the processes including loading, linking, initialization and the like should be performed. Furthermore, the linking process includes the processes of verification, preparation, resolution, etc. Therefore, there is a problem in that a lot of time is spent in performing the class loading process.

In particular, as for the same byte codes, the verification process among the class loading process can be performed only when the Java program is initially executed. However, the current class loading process is designed such that the verification process is performed whenever the Java program is executed. Thus, the conventional class loading process has problems in that in a system such as a mobile terminal with a low-performance CPU and a low-capacity battery, system response time is increased and the battery is rapidly exhausted.

Further, as the size of a Java program becomes larger, time spent in loading the program is generally increased. In such a case, accordingly, the aforementioned problems related to system response time and battery life become even more severe.

### SUMMARY OF THE INVENTION

The present invention is conceived to solve the aforementioned problems. An object of the present invention is to provide a system and method for shortening the class loading process in a Java program, wherein runtime data generated upon performing the class loading process in the Java program are stored in the form of images and the stored runtime data are retrieved and executed upon future execution of the Java program, thereby shortening the class loading time.

Another object of the present invention is to provide a system and method for shortening the class loading process in a Java program, wherein the processing speed of the Java program is improved in equipment with a low-performance CPU and/or a low-capacity battery, thereby reducing response time to a user and conserving battery power.

According to an aspect of the present invention for achieving the objects, there is provided a system for shortening the class loading process in a Java program, comprising a class loader unit for loading Java program class files from an auxiliary memory, performing linking and initialization processes and generating runtime data; a first memory unit for maintaining the runtime data generated by the class loader unit in an accessible state; a second memory unit for storing the runtime data, which have been loaded into the first memory unit in an accessible state, in the form of images; a runtime data search unit for loading the runtime data, which have been stored in the second memory unit in the form of images, into the first memory unit upon the request of the class loader unit; and an execution unit for executing the runtime data that have been loaded into the first memory unit in an accessible state.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram schematically showing a system for shortening the class loading process in a Java program according to the present invention;

FIG. 2 is a flowchart schematically illustrating a method for shortening the class loading process in a Java program according to the present invention; and

FIG. 3 is a flowchart specifically illustrating a process of generating runtime data shown in FIG. 2.

### DETAILED DESCRIPTION OF THE INVENTION

Hereinafter, preferred embodiments of the present invention will be described in detail with reference to the accompanying drawings.

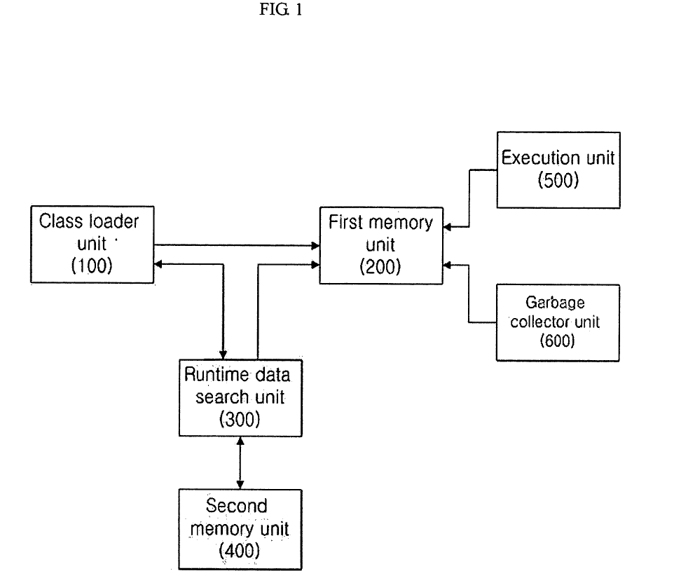

FIG. 1 is a block diagram schematically showing a system for shortening the class loading process in a Java program. The system comprises a class loader unit 100, a first memory unit 200, a runtime data search unit 300, a second memory unit 400, an execution unit 500, and a garbage collector unit 600.

The class loader unit 100 loads Java program class files from an auxiliary memory, performs linking and initialization processes, and then generates runtime data. Here, the loading process means a process of loading the class files, located in the auxiliary memory unit, into a Java virtual machine. Further, the linking process means a process of causing the loaded class files to be processed into a state where they can be executed by the Java virtual machine, and includes the processes of verification, preparation, resolution, etc. The runtime data are loaded into the first memory unit 200 and used for executing the Java program. The runtime data can be understood as a constant pool, method table, field table, etc.

The first memory unit 200 maintains the runtime data generated by the class loader unit 100 in an accessible state. That is, the runtime data generated by the class loader unit 100 are stored in predetermined memory areas so that the execution unit 500 to be described later can access the stored runtime data.

The second memory unit 400 stores the runtime data, which have been loaded into the first memory unit 200 in an accessible state, in the form of images.

The runtime data search unit 300 loads the runtime data stored in the second memory unit 400 into the first memory unit 200 upon the request of the class loader unit 100. Further, the runtime data search unit 300 stores the runtime data, which have been generated by the class loader unit 100, in the second memory unit 400 in the form of images. In addition, the runtime data search unit 300 manages the runtime data, which have been stored in the second memory unit 400 in the form of images, by using the least recently used (LRU) method. Here, according to the LRU method, rarely used data among the stored data are checked and then deleted in order of rarity of use thereof.

The execution unit 500 executes the runtime data loaded into the first memory unit 200 in an accessible state.

The garbage collector unit 600 collects memory areas not used in the first memory unit 200 to allow the unused areas to be used again, thereby securing more usable areas in the first memory unit 200.

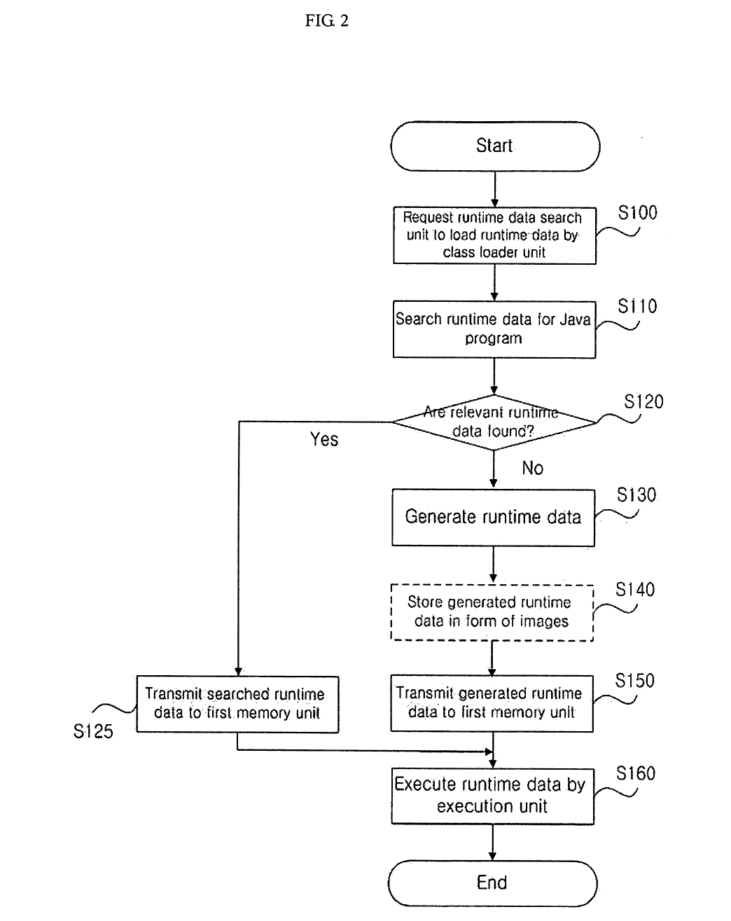

FIG. 2 is a flowchart schematically illustrating a method for shortening the class loading process in a Java program according to the present invention.

First, the class loader unit 100 requests the runtime data search unit 300 to search runtime data necessary for the execution of a Java program (S100), and then, the runtime data search unit 300 searches whether the runtime data exist in the second memory unit 400 (S110).

If the relevant runtime data are found in the second memory unit 400 (S120), the searched runtime data are transmitted to the first memory unit 200 (S125). Then, the execution unit 500 executes the runtime data transmitted to the first memory unit 200 (S160). Here, the runtime data stored in the second memory unit 400 can be image files, i.e. files in which the runtime data generated upon execution of the previous Java program are stored in the form of images.

Meanwhile, according to the present invention, the runtime data that have been previously generated and stored in the second memory unit 400 are simply loaded into and executed in the first memory unit 200. Thus, it is not necessary to generate the runtime data whenever executing the Java program, thereby eliminating a complicated loading process needed for generating the runtime data. Accordingly, class loading time can be reduced.

Furthermore, if there are no relevant runtime data as a result of the search of the second memory unit 400 by the runtime data search unit 300, the class loader unit 100 generates runtime data necessary for execution of the Java program (S130).

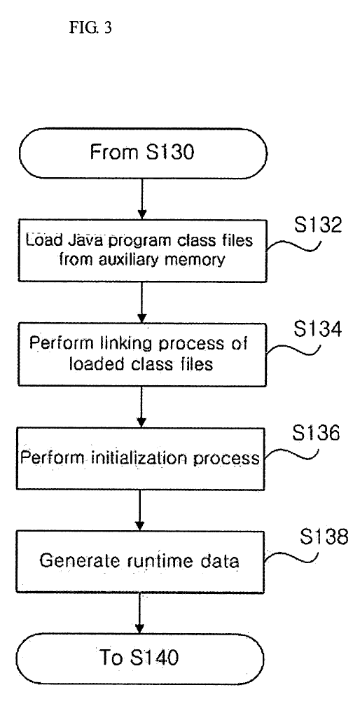

A process of generating runtime data will be discussed with reference to FIG. 3. First, the Java program class files are loaded from the auxiliary memory (S132), and the runtime data are generated by performing the linking and initialization processes for the loaded class files (S134 to S138). Here, the loading process means a process of loading the class files, located in the auxiliary memory, into the Java virtual machine; and the class file linking process means a process of causing the loaded class files to be processed into a state where they can be executed by the Java virtual machine. More specifically, the linking process includes the verification process of verifying whether the loaded class file contains correct class formats, the preparation process of allocating the memory areas, and the resolution process of converting the class files into executable ones.

After performing the linking process, the class files are initialized and the runtime data are generated. The runtime data search unit 300 stores the generated runtime data in the second memory unit 400 in the form of images (S140). At this time, the runtime data search unit 300 manages the image data stored in the second memory unit 400 according to the LRU method. That is, since there are limitations in storage areas of the second memory unit 400, the LRU method is employed to manage the stored data.

Thereafter, the runtime data search unit 300 transmits the runtime data stored in the form of images to the first memory unit 200 (S150), and the execution unit 500 executes the runtime image data transmitted to the first memory unit 200 (S160). Here, if the first memory unit 200 lacks space for data loading, the garbage collector unit 600 collects space unused in the first memory unit 200 and allows the collected space to be used again, thereby securing more space in the first memory unit 200.

Alternatively, step S140 may be performed after step S160. That is, when the runtime data are generated (S130), the generated runtime data are transmitted to the first memory unit 200 (S150) and the transmitted runtime data are executed (S160). Then, after the execution of the Java program is completed, the runtime data may be stored in the second memory unit 400.

According to the present invention, the runtime data generated upon performing the class loading process in the Java program are stored in the form of images and the stored runtime data are retrieved and executed upon future execution of the Java program, whereby the Java program can be executed without performing the complicated class loading process. Thus, there is an advantage in that class loading time can be shortened upon the execution of a Java program.

Further, the processing speed of Java programs is improved in equipment with a low-performance CPU and/or a low-capacity battery, thereby reducing response time to a user and conserving battery power.

Although the present invention has been described in connection with the exemplary embodiments thereof shown in the accompanying drawings, they are mere examples of the present invention. It can also be understood by those skilled in the art that various changes and modifications thereof can be made thereto without departing from the scope and spirit of the present invention defined by the claims. Therefore, simple changes to the embodiments of the present invention fall within the scope of the present invention.

What is claimed is:

1. A system for shortening a class loading process in a Java program, comprising:
a class loader unit for loading Java program class files from an auxiliary memory, performing linking and initialization processes and generating runtime data;
a first memory unit for maintaining the runtime data generated by the class loader unit in an accessible state;
a second memory unit for storing the runtime data, which have been loaded into the first memory unit in the accessible state, in a form of images;
a runtime data search unit for loading the runtime data, which have been stored in the second memory unit in the form of images, into the first memory unit upon the request of the class loader unit; and
an execution unit for executing the runtime data that have been loaded into the first memory unit in the accessible state.

2. The system as claimed in claim 1, further comprising a garbage collector unit for collecting space unused in the first memory unit and allowing the unused space to be used again.

3. The system as claimed in claim 1, wherein the runtime data search unit causes the runtime data generated by the class loader unit to be stored in the second memory unit in the form of images.

4. The system as claimed in claim 1 , wherein the runtime data search unit manages the runtime data, which have been stored in the second memory unit in the form of images, by using a least recently used (LRU) method.

5. The system as claimed in claim 3, wherein the runtime data search unit manages the runtime data, which have been stored in the second memory unit in the form of images, by using a least recently used (LRU) method.

6. A method for shortening a class loading process in a Java program, comprising the steps of:
requesting a runtime data search unit to search runtime data necessary for execution of the Java program, by a class loader unit;
searching the requested runtime data for the Java program by the runtime data search unit;
transmitting the searched runtime data to a first memory unit; and
executing the runtime data transmitted to the first memory unit.

7. The method as claimed in claim 6, wherein the searched runtime data are stored in a second memory unit in a form of images.

8. The method as claimed in claim 7, wherein the runtime image data stored in the second memory unit are managed by the runtime data search unit according to a least recently used (LRU) method.

9. The method as claimed in claim 6, further comprising the steps of, if it is determined from search results of the requested runtime data for the Java program that there are no relevant runtime data,
loading Java program class files from an auxiliary memory;
generating runtime data by performing linking and initialization processes of the loaded Java program class files;
storing the generated runtime data in a form of images; and
transmitting the runtime image data to the first memory unit.

10. The method as claimed in claim 9, wherein the step of storing the generated runtime data in the form of images is performed after the step of executing the runtime data transmitted to the first memory unit.

11. The method as claimed in claim 9, wherein the stored runtime image data are managed by the runtime data search unit according to a least recently used (LRU) method.
